(19) United States
(12) Patent Application Publication
(10) Pub. No.: US 2010/0244461 A1
(43) Pub. Date: Sep. 30, 2010

(54) SYSTEM FOR INCREASING ELECTRICAL OUTPUT POWER OF AN EXHAUST GAS TURBINE GENERATOR SYSTEM

(75) Inventor: Gerhard E. DELF, Ojai, CA (US)

Correspondence Address: Arent Fox LLP, 555 West Fifth Street, 48th Floor, Los Angeles, CA, 90013, US

(73) Assignee: ThinGap Automotive, LLC

(21) Appl. No.: 12/544,992

(22) Filed: Aug. 20, 2009

Related U.S. Application Data
(63) Continuation-in-part of application No. 12/413,453, filed on Mar. 27, 2009.
(60) Provisional application No. 61/185,301, filed on Jun. 9, 2009.

(51) Int. Cl. H02P 9/04; F02G 5/02

(52) U.S. Cl. 290/40 F; 60/597

(57) ABSTRACT

A system for increasing electrical power includes an exhaust gas turbine, a generator, and a controller. The exhaust gas turbine is configured to be driven by exhaust gas from an engine. The generator is coupled to the exhaust gas turbine to produce electrical power for an electrical load. The controller is configured to increase the electrical power produced by the generator in response to a certain decrease in an electrical load voltage of the electrical load when the engine is at idle. The controller increases the electrical power by increasing a throughput of the exhaust gas through the exhaust gas turbine.

### CROSS-REFERENCE TO RELATED APPLICATION(S)

This application is a continuation-in-part of, and pursuant to 35 U.S.C. §120, claims the benefit of U.S. application Ser. No. 12/413,453, entitled “Turbo Generator” and filed on Mar. 27, 2009. Pursuant to 35 U.S.C. §119(e), this application claims the benefit of U.S. Provisional Application Ser. No. 61/185,301 filed on Jun. 9, 2009. The contents of both applications are hereby incorporated by reference herein in their entirety.

### BACKGROUND

1. Field

The present disclosure relates to a system for increasing electrical output power and, more particularly, to a system for increasing electrical output power of an exhaust gas turbine generator system.

2. Description of Related Art

Electrical power may be generated from vehicle exhaust gas with the use of an exhaust gas turbine generator. However, when a vehicle engine is at idle, the flow of vehicle exhaust gas reduces such that the exhaust gas turbine generator may not generate sufficient electrical power to support the vehicle's electrical load and to charge the vehicle's battery. As such, there is a need for a system that allows an exhaust gas turbine generator to generate, from vehicle exhaust gas, sufficient electrical power to support the vehicle's electrical load and to charge the vehicle's battery while the vehicle engine is at idle.

### SUMMARY

In one aspect of the disclosure, a system for increasing electrical power includes an exhaust gas turbine, a generator, and a controller. The exhaust gas turbine is configured to be driven by exhaust gas from an engine. The generator is coupled to the exhaust gas turbine to produce electrical power for an electrical load. The controller is configured to increase the electrical power produced by the generator in response to a certain decrease in an electrical load voltage of the electrical load when the engine is at idle. The controller increases the electrical power by increasing a throughput of the exhaust gas through the exhaust gas turbine.

In another aspect of the disclosure, a method for providing electrical power to an electrical load while an engine is at idle includes increasing a flow of exhaust gas from the engine through an exhaust gas turbine in response to a certain decrease in an electrical load voltage of the electrical load, and increasing electrical power to the electrical load through the increase in the exhaust gas flow through the exhaust gas turbine.

In yet another aspect of the disclosure, a system for increasing electrical power includes means for producing electrical power from a flow of exhaust gas from an engine. The means for producing electrical power is configured to provide the electrical power to an electrical load. The system further includes means for increasing the electrical power provided to the electrical load by increasing a throughput of the flow of the exhaust gas through the means for generating power. The means for increasing the electrical power is configured to increase the electrical power in response to a certain decrease in an electrical load voltage of the electrical load when the engine is at idle.

In yet another aspect of the disclosure, a vehicle having a system for increasing electrical power includes an electrical load, an engine, an exhaust gas turbine, a generator, and a controller. The electrical load includes a battery and a vehicle electrical load. The engine is configured to output exhaust gas. The exhaust gas turbine is configured to be driven by the exhaust gas from an engine. The generator is coupled to the exhaust gas turbine to output electrical power to the electrical load. The controller is configured to increase the electrical power produced by the generator when the engine is at idle and an electrical load voltage of the electrical load crosses a lower threshold. The controller increases the electrical power by increasing a throughput of the exhaust gas through the exhaust gas turbine.

In a further aspect of the disclosure, an apparatus for use in an automobile includes a variable turbine geometry (VTG) turbine configured to be driven by exhaust gas from an engine, and a generator coupled to the VTG turbine to produce electrical power for an electrical load.

In yet a further aspect of the disclosure, an apparatus for use in an automobile includes an exhaust gas turbine configured to be driven by exhaust gas from an engine. The exhaust gas turbine includes means for varying an energy throughput of the exhaust gas through the exhaust gas turbine and a generator coupled to the exhaust gas turbine to produce electrical power for an electrical load. The electrical power produced by the generator is based on the energy throughput of the exhaust gas through the exhaust gas turbine.

It is understood that other aspects of a system for increasing electrical output power of an exhaust gas turbine generator system will become readily apparent to those skilled in the art from the following detailed description, wherein it is shown and described only exemplary configurations of a system for increasing electrical output power of an exhaust gas turbine generator system. As will be realized, the invention includes other and different aspects of a system for increasing electrical output power of an exhaust gas turbine generator system and the various details presented throughout this disclosure are capable of modification in various other respects, all without departing from the spirit and scope of the invention. Accordingly, the drawings and the detailed description are to be regarded as illustrative in nature and not as restrictive.

### BRIEF DESCRIPTION OF THE DRAWINGS

FIG. 1 is an interconnectivity chart of a system for increasing electrical output power of an exhaust gas turbine generator system.

FIG. 2a is a technology schematic of the system of FIG. 1 according to a first configuration.

FIG. 2b is a technology schematic of the system of FIG. 1 according to a second configuration.

FIG. 3a is a technology schematic of the system of FIG. 1 according to a third configuration.

FIG. 3b is a technology schematic of the system of FIG. 1 according to a fourth configuration.

FIG. 4 is a signal flow chart corresponding to FIGS. 2a-3b.

FIG. 5 is a control flow chart for the engine electronic control unit.

FIG. 6 is a device/parameter state chart corresponding to FIGS. 2a-3b.

FIG. 7 is a technology schematic of the system of FIG. 1 according to a fifth configuration.

FIG. 8 is a signal flow chart corresponding to FIG. 7.

FIG. 9 is a device/parameter state chart corresponding to FIG. 7.

FIG. 10 is a technology schematic of the system of FIG. 1 according to a sixth configuration.

FIG. 11 is a signal flow chart corresponding to FIG. 10.

FIG. 12 is a device/parameter state chart corresponding to FIG. 10.

### DETAILED DESCRIPTION

The present invention is described more fully hereinafter with reference to the accompanying drawings, in which various aspects of a system for increasing electrical output power of an exhaust gas turbine generator system are shown. This invention, however, may be embodied in many different forms and should not be construed as limited by the various aspects of the system for increasing electrical output power of an exhaust gas turbine generator system presented herein. The detailed description of the system for increasing electrical output power of an exhaust gas turbine generator system is provided below so that this disclosure will be thorough and complete, and will fully convey the scope of the present invention to those skilled in the art.

The detailed description may include specific details for illustrating various aspects of a system for increasing electrical output power of an exhaust gas turbine generator system. However, it will be apparent to those skilled in the art that the invention may be practiced without these specific details. In some instances, well known elements may be shown in system diagram form, or omitted, to avoid obscuring the inventive concepts presented throughout this disclosure.

Various aspects of a system for increasing electrical output power of an exhaust gas turbine generator system may be illustrated by describing components that are coupled together. As used herein, the term “coupled” is used to indicate either a direct connection between two components or, where appropriate, an indirect connection to one another through intervening or intermediate components. In contrast, when a component referred to as being “directly coupled” to another component, there are no intervening elements present.

Various aspects of a system for increasing electrical output power of an exhaust gas turbine generator system may be illustrated with reference to one or more exemplary embodiments.

As used herein, the term “exemplary” means “serving as an example, instance, or illustration,” and should not necessarily be construed as preferred or advantageous over other embodiments of a system for increasing electrical output power of an exhaust gas turbine generator system disclosed herein.

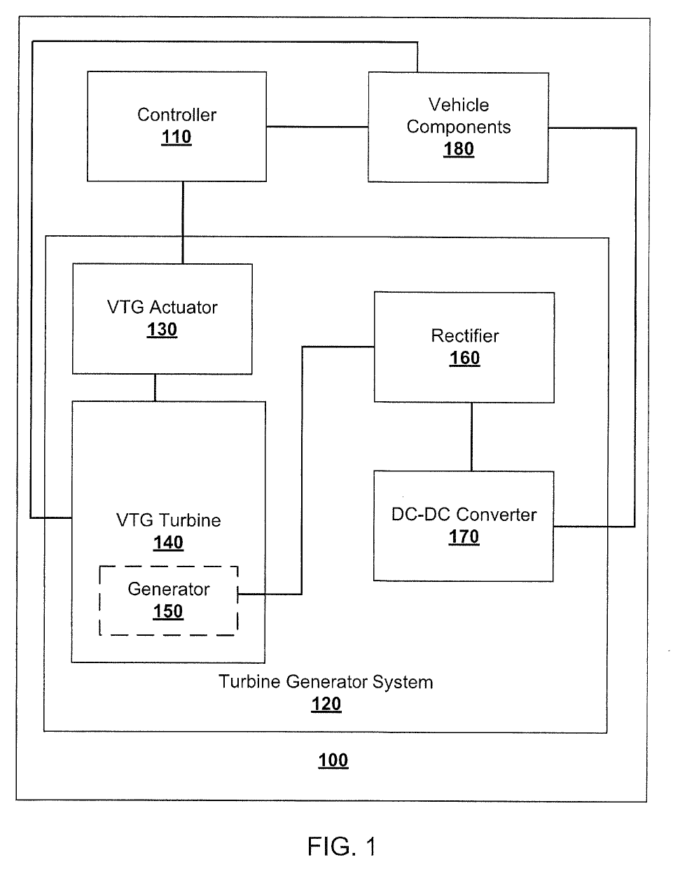

FIG. 1 is an interconnectivity chart of a system 100 for increasing electrical output power of an exhaust gas turbine generator system. Several configurations of the exhaust gas turbine generator system are disclosed in U.S. patent application Ser. No. 12/413,453. As shown in FIG. 1, the system 100 includes a controller 110, a turbine generator system 120, and vehicle components 180. The controller 110 may be the engine electronic control unit (ECU) or the engine controller of a vehicle and therefore be part of the vehicle components 180. Alternatively, the controller 110 may be a component separate from the engine ECU/controller. The turbine generator system 120 includes a variable turbine geometry (VTG) actuator 130, a VTG turbine 140, a generator 150, a rectifier 160, and a DC-DC converter 170. The controller 110 is coupled to the VTG actuator 130, which is coupled to the VTG turbine 140. The VTG turbine 140 includes the generator 150 for generating electricity. The generator 150 is coupled to the rectifier 160 and the rectifier 160 is coupled to the DC-DC converter 170. The DC-DC converter 170 is coupled to the vehicle components 180, which is coupled to the controller 110. The vehicle components 180 are also coupled to the VTG turbine 140.

The system 100 increases electrical output power of the VTG turbine 140/generator 150 by controlling the VTG actuator 130 to make adjustments to the VTG turbine 140 that result in a decrease in engine idle speed and torque or by controlling the vehicle components 180 to decrease the engine idle speed and torque. The controller 110 and the vehicle components 180 then compensate in order to increase engine idle speed and torque, which results in an increase in exhaust gas energy and, thus, electrical output power of the VTG turbine 140/generator 150.

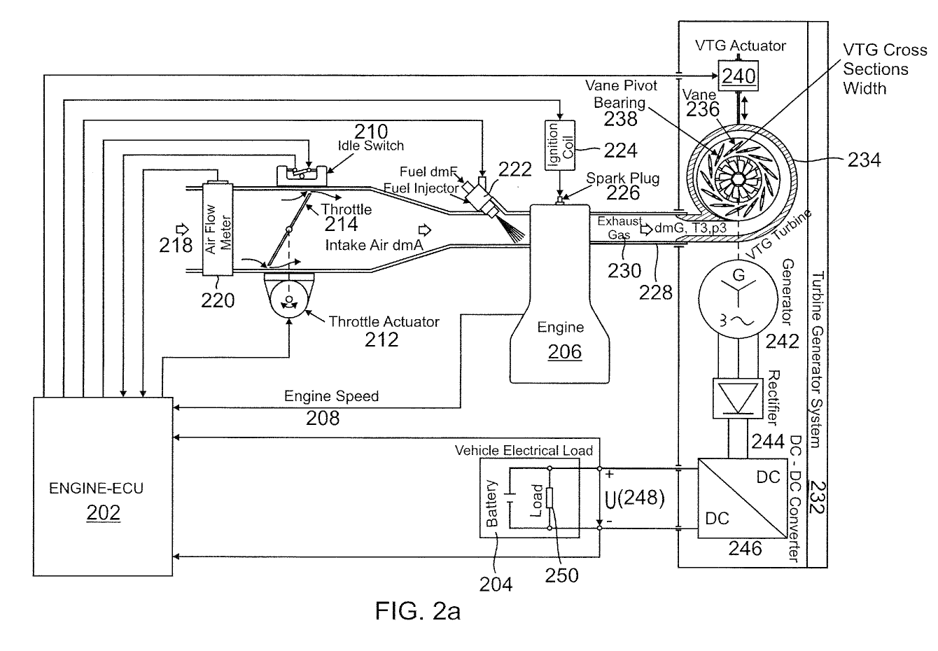

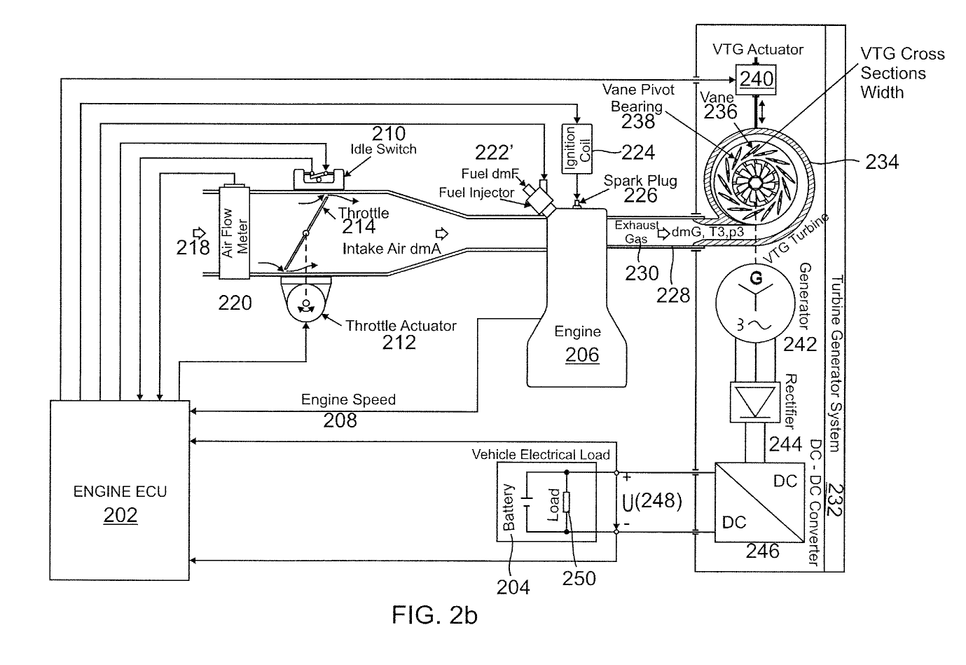

FIG. 2a and FIG. 2b are technology schematics of the system 100 of FIG. 1 according to first and second configurations, respectively. As shown in FIG. 2a and FIG. 2b, the controller 110 is the engine ECU 202. However, as discussed supra, the controller 110 may be a separate component from the engine ECU 202. The engine ECU 202 is coupled to and powered by the battery 204 and/or the generator as part of the load. Accordingly, the engine ECU 202 receives voltage U (248). The engine ECU 202 receives information on whether the engine 206, which is a spark ignition engine, is at idle from the idle switch 210. When the idle switch 210 is activated, the engine 206 is at idle. The engine ECU 202 can control ignition timing through the ignition coil 224. The ignition coil(s) 224 is/are coupled to the spark plugs 226 of the vehicle. The spark plugs 226 are inserted into the engine 206. The engine ECU 202 receives engine speed information 208 from the engine 206. Depending on the engine speed information 208, the engine ECU 202 controls the throttle actuator 212, which itself controls the throttle 214, in order to allow more air 218 into the engine 206. The engine ECU 202 receives information on air flow 218 into the engine 206 from the air flow meter 220. According to the air flow information, the engine ECU 202 controls the fuel injector 222/222′.

The engine 206 may be configured with conventional intake system injection (i.e., port injection) as shown in FIG. 2a. Alternatively, the engine 206 may be configured with direct injection as shown in FIG. 2b. For direct injection, the fuel injector 222′ is located in the cylinder head and injects fuel directly into the combustion chamber of the engine 206. When the engine 206 is configured with direct injection, the engine 206 may operate in either a homogeneous mode or a stratified charge mode (described infra). In a homogeneous mode, the load (power) of the engine 206 is controlled through the amount of fuel provided by the fuel injector 222′, determined by the air flow into the engine 206 as controlled by the position of the throttle 214. In a stratified charge mode, the load (power) of the engine 206 is controlled only through the amount of fuel provided by the fuel injector 222′, as the throttle 214 is always open.

The engine 206 is coupled to the exhaust outlet 228. Exhaust gas 230 from the engine 206 flows out the exhaust outlet 228 and through the VTG turbine 234 of the turbine generator system 232. The VTG turbine 234 includes a plurality of vanes 236, which can be rotated clockwise or counterclockwise via pivot bearing 238. When the vanes 236 are rotated counterclockwise, the VTG cross-section width increases (i.e., a channel width between adjacent vanes increases), and when the vanes 236 are rotated clockwise, the VTG cross-section width decreases (i.e., a channel width between adjacent vanes decreases). As the VTG cross-section width decreases, the back pressure on the exhaust gas 230 increases, as there is less area through which the exhaust gas 230 can flow. The vanes 236 are controlled by the VTG actuator 240, which itself is coupled to the engine ECU 202. The VTG turbine 234 includes generator 242. The generator 242 generates an AC voltage, which is rectified by the rectifier 244. A DC-DC converter 246 is coupled to the rectifier 244. The DC-DC converter 246 provides a voltage U (248) across vehicle electrical load 250 for providing power to the vehicle electrical load 250 and for charging the battery 204.

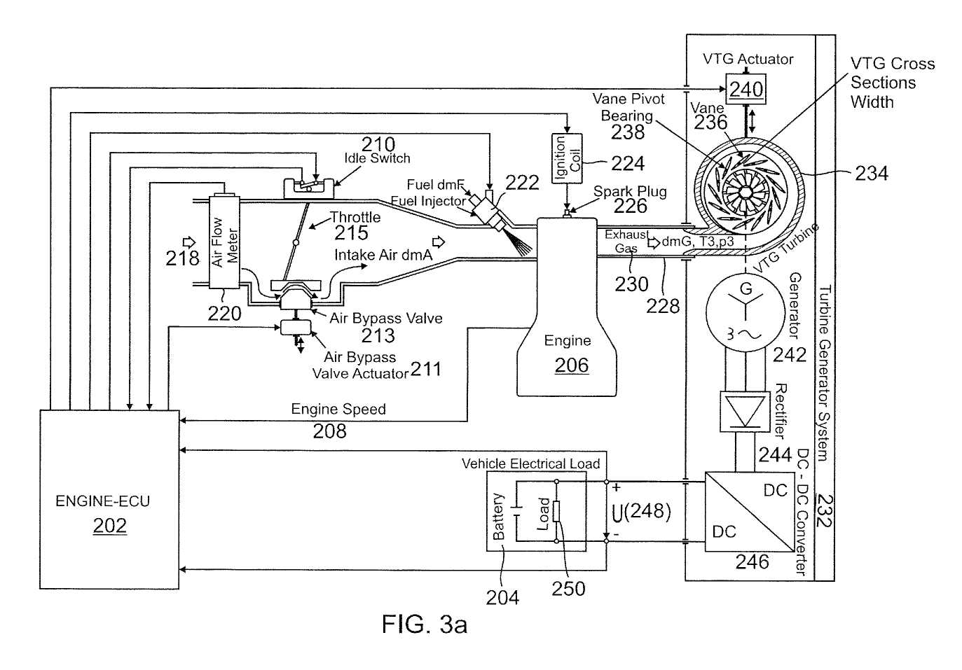

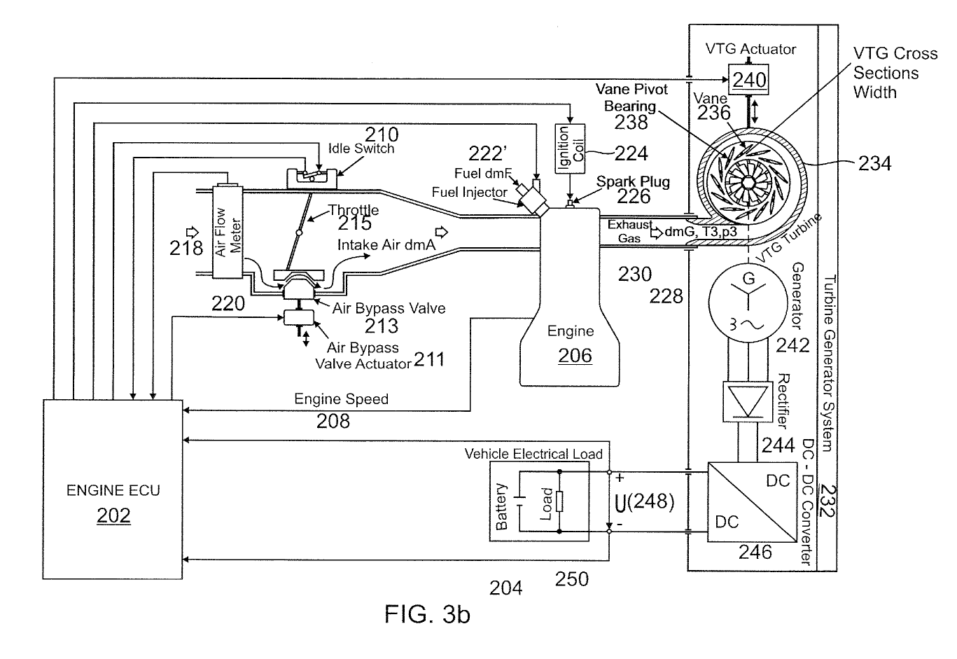

FIG. 3a and FIG. 3b are technology schematics of the system 100 of FIG. 1 according to third and fourth configurations, respectively. As shown in FIG. 3a and FIG. 3b, if a vehicle has an air bypass valve actuator 211 and an air bypass valve 213 rather than a throttle actuator 212, then depending on the engine speed information 208, the engine ECU 202 controls the air bypass valve actuator 211 to operate the air bypass valve 213 in order to bypass the throttle 215 to allow more intake air 218 into the engine 206. The engine 206 may be configured with port injection with fuel injector 222 or with direct injection with fuel injector 222′

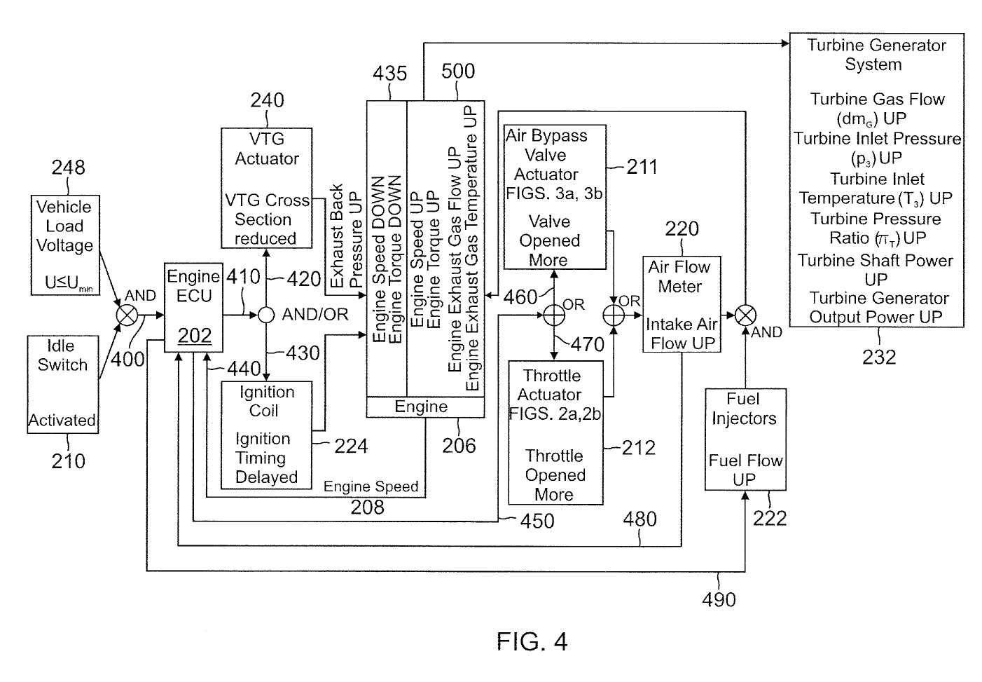

FIG. 4 is a functional flow chart of the system 100 of FIG. 1. Referring to FIG. 2a, FIG. 2b, FIG. 3a, FIG. 3b, and FIG. 4, when the engine ECU 202 receives information that the idle switch 210 is activated, the engine ECU 202 determines that the engine is at idle. If the engine ECU 202 also determines that the voltage U (248) is equal to or has dropped below a predetermined voltage Uₘᵢₙ, the engine ECU 202 initiates an action to increase the voltage U (248) (see FIGS. 2a-3b). Accordingly, upon the engine ECU 202 determining that the engine is at idle and that the voltage U (248) is less than or equal to a predetermined voltage Uₘᵢₙ (step 400), the engine ECU 202 decreases the engine idle speed (step 410) by controlling the VTG actuator 240 to reduce the VTG cross-section width between the vanes 236 (step 420) in order to increase the back pressure on the exhaust gas 230. An increase of the back pressure on the exhaust gas 230 decreases the engine idle speed and the engine torque of the engine 206 (step 435). Alternatively, the engine ECU 202 may decrease the engine idle speed (step 410) and engine torque by controlling the ignition signal to the ignition coil 224 to delay the ignition timing (step 430). As such, the engine ECU 202 may control the VTG actuator 240 (step 420) and/or the ignition signal to the ignition coil 224 (step 430) in order to decrease the engine idle speed and the engine torque of the engine 206 (step 435). When the engine ECU 202 receives information 208 that the engine speed has decreased (step 440), the engine ECU 202 controls (step 450) either the throttle actuator 212 (FIGS. 2a, 2b) (step 460) or the air bypass valve actuator 211 (FIGS. 3a, 3b) (step 470), depending on the particular configuration of the vehicle, to allow more intake air 218 into the engine 206. When the engine ECU 202 receives information on an increase of air flow 218 into the engine 206 from the air flow meter 220 (step 480), the engine ECU 202 controls the fuel injector 222/222′ to provide more fuel for combustion in the engine 206 (step 490). The increase in fuel and air to the engine 206 results in an increase in engine speed and engine torque (step 500). The resulting engine speed after step 500 is approximately the same as the engine speed before the initial decrease in engine speed at step 410. The increase in engine speed and engine torque results in an increase in engine exhaust gas temperature, an increase in engine exhaust gas flow (step 500), and an increase in turbine inlet pressure. That is, more exhaust gas with higher temperature flows through the turbine with a higher expansion ratio (pressure ratio) over the turbine. That increases the turbine shaft power (generator input power) and, consequently, increases the turbine generator output power. Accordingly, the generator 242 may generate a sufficient AC power, which upon being rectified by the rectifier 244 and controlled by the DC-DC converter 246, is provided as power with voltage U (248) (see FIGS. 2a-3b) for supplying power to the vehicle electrical load and for charging the battery 204.

By way of example, if the normal vehicle electrical load voltage U (248) is in the range of 13V to 14.6V, and the vehicle electrical load voltage U (248) is equal to or drops below a predetermined voltage Uₘᵢₙ (i.e., crosses a first threshold) in the range of 12V to 12.2V while the engine is at idle, the system 100 increases the electrical output power of the turbine generator system 232 until the voltage U (248) is within the nominal voltage range of the vehicle electrical load (i.e., crosses a second threshold), which in the present example is 14V to 14.6V. As such, once the voltage U (248) is within the nominal voltage range of the vehicle electrical load while the idle switch is still activated, all functions for increasing electrical output power of the exhaust gas turbine generator system are deactivated.

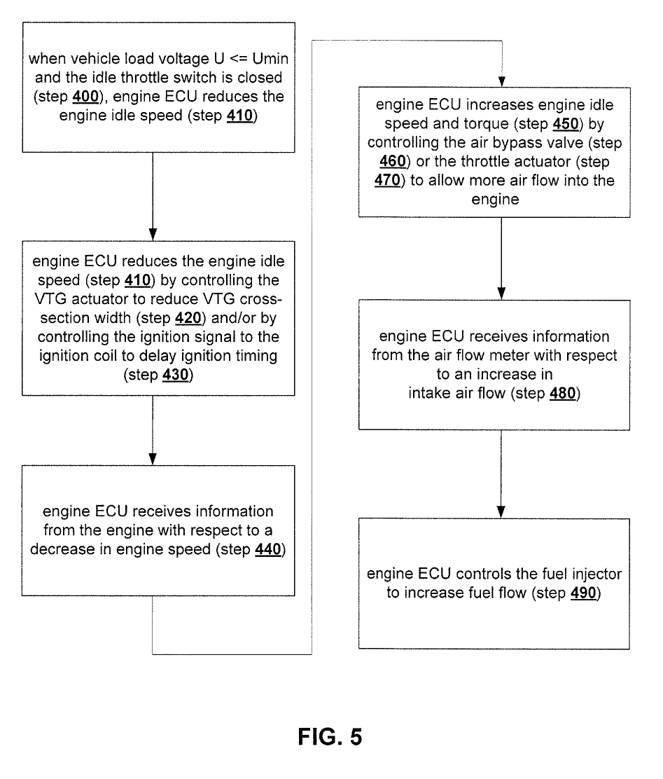

FIG. 5 is a control flow chart for the engine ECU 202. Referring to FIG. 4 and FIG. 5, when a vehicle load voltage U (248) is less than or equal to a predetermined voltage Uₘᵢₙ (i.e., U≦Uₘᵢₙ) and the idle switch 210 is activated (step 400) (i.e., the engine is at idle), the engine ECU 202 reduces the engine idle speed (step 410). The engine ECU 202 reduces the engine idle speed (step 410) by controlling the VTG actuator 240 to reduce the VTG cross-section width (step 420) (which increases exhaust gas back pressure) and/or by controlling the ignition signal to the ignition coil 224 to delay ignition timing (step 430). After the engine ECU 202 receives information 208 from the engine 206 indicating a decrease in engine speed (step 440), the engine ECU 202 increases engine idle speed and torque (step 450) by controlling the air bypass valve actuator 211 (step 460) or the throttle actuator 212 (step 470), depending on the configuration of the vehicle, to allow more air flow into the engine 206. When the engine ECU 202 receives information from the air flow meter 220 indicating an increase of intake air flow (step 480), the engine ECU 202 controls the fuel injector 222/222′ to increase fuel flow to the engine 206 (step 490), which results in an increase in engine exhaust gas temperature, an increase in engine exhaust gas flow (step 500), and an increase in turbine inlet pressure. That is, more exhaust gas with higher temperature flows through the turbine with a higher expansion ratio (pressure ratio) over the turbine. That increases the turbine shaft power (generator input power) and, consequently, increases the turbine generator output power.

As discussed supra, the system for increasing electrical output power includes means for generating electrical output power from a flow of exhaust gas and includes means for increasing electrical output power of the means for generating power by increasing a throughput of the energy of the exhaust gas flow through the means for generating power. The means for generating electrical output power includes an exhaust gas turbine and a generator coupled to the exhaust gas turbine. The exhaust gas turbine may be a VTG turbine. The means for increasing electrical output power includes a controller, which may be an engine ECU. The engine ECU is configured with the algorithm of FIG. 5. The system for increasing electrical output power of an exhaust gas turbine generator system may eliminate the need for a vehicle to have a crankshaft driven alternator or may allow for a vehicle to have a smaller crankcase driven alternator than would otherwise be required.

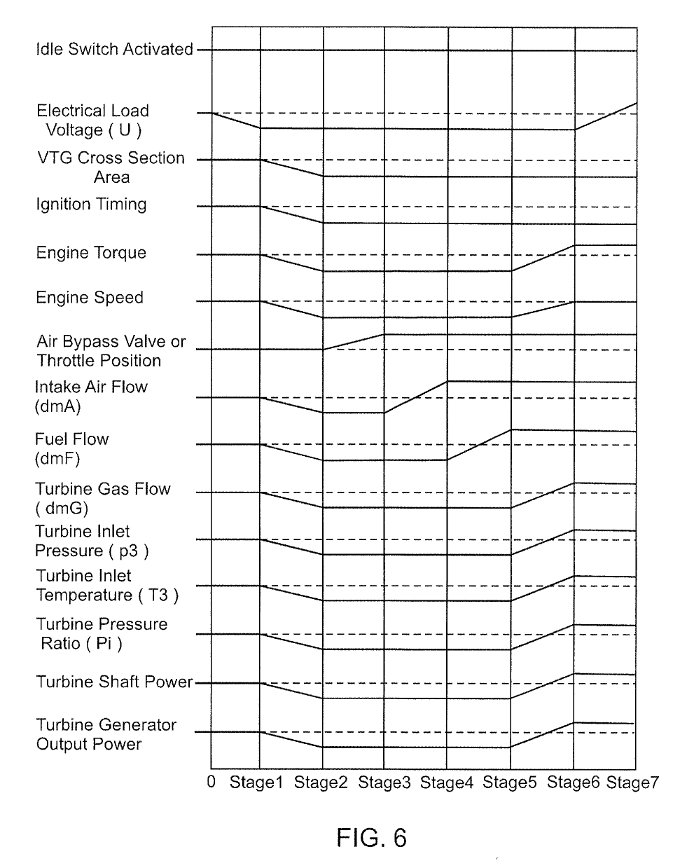

FIG. 6 is a device/parameter state chart. At stage 0, the idle switch is activated, which indicates that the engine is at idle. At stage 1, the electrical load voltage U has fallen such that the voltage U is less than or equal to a predetermined voltage. As discussed supra, the system increases the electrical output power of the exhaust gas turbine generator system only when the engine is at idle and the voltage U is less than or equal to the predetermined voltage Uₘᵢₙ. At stage 2, the VTG cross-section width (i.e., the width between adjacent vanes) is decreased and/or the ignition timing is delayed, which results in a decrease in the engine torque and engine speed. Concurrently, the intake air flow, the fuel flow, the turbine gas flow, the turbine inlet pressure, the turbine inlet temperature, the turbine pressure ratio, the turbine shaft power, and the turbine generator electrical output power all decrease. At stage 3, the air bypass valve or the throttle position, depending on the configuration of the vehicle, is adjusted to allow more intake air flow into the engine. Consequently, at stage 4, the intake air flow into the engine is increased. At stage 5, the fuel flow into the engine is increased. As a result, at stage 6, the engine torque, the engine speed, the turbine gas flow, the turbine inlet pressure, the turbine inlet temperature, the turbine pressure ratio, the turbine shaft power, and the turbine generator electrical output power all are increased. At stage 7, the electrical load voltage U is increased as a result of the increase in electrical output power of the exhaust gas turbine generator system.

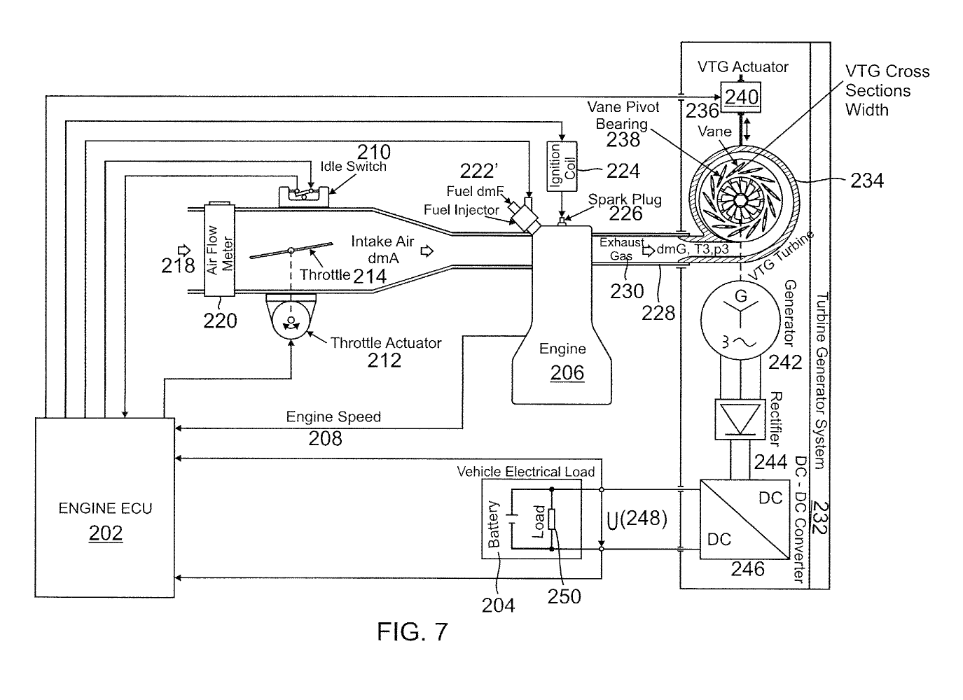

FIG. 7 is a technology schematic of the system of FIG. 1 according to a fifth configuration. As shown in FIG. 7, the controller 110 is the engine ECU 202. However, as discussed supra, the controller 110 may be a separate component from the engine ECU 202. The engine ECU 202 is coupled to and powered by the battery 204 and/or the generator as part of the load. Accordingly, the engine ECU 202 receives voltage U (248). The engine ECU 202 receives information on whether the engine 206, which is a spark ignition engine, is at idle from the idle switch 210. When the idle switch 210 is activated, the engine 206 is at idle. The engine ECU 202 can control ignition timing through the ignition signal to the ignition coil 224. The ignition coil 224 is coupled to the spark plugs 226 of the vehicle. The spark plugs 226 are inserted into the engine 206. The engine ECU 202 receives engine speed information 208 from the engine 206. Depending on the engine speed information 208, the engine ECU 202 controls the fuel injector 222′.

The engine 206 is configured with direct injection in which the fuel injector 222′ is located in the cylinder head and injects fuel directly into the combustion chamber of the engine 206. As described supra, when the engine 206 is configured with direct injection, the engine 206 may operate in either a homogeneous mode or a stratified charge mode. As shown and described in relation to FIG. 7, the engine 206 is operating in a stratified charge mode with the throttle 214 open and the load (power) of the engine 206 controlled only through the amount of fuel provided by the fuel injector 222′.

The engine 206 is coupled to the exhaust outlet 228. Exhaust gas 230 from the engine 206 flows out the exhaust outlet 228 and through the VTG turbine 234 of the turbine generator system 232. The VTG turbine 234 includes a plurality of vanes 236, which can be rotated clockwise or counterclockwise via pivot bearing 238. When the vanes 236 are rotated counterclockwise, the VTG cross-section width increases, and when the vanes 236 are rotated clockwise, the VTG cross-section width decreases. As the VTG cross-section width decreases, the back pressure on the exhaust gas 230 increases, as there is less area through which the exhaust gas 230 can flow. The vanes 236 are controlled by the VTG actuator 240, which itself is coupled to the engine ECU 202. The VTG turbine 234 includes generator 242. The generator 242 generates an AC voltage, which is rectified by the rectifier 244. A DC-DC converter 246 is coupled to the rectifier 244. The DC-DC converter 246 provides a voltage U (248) across vehicle electrical load 250 for providing power to the vehicle electrical load 250 and for charging the battery 204.

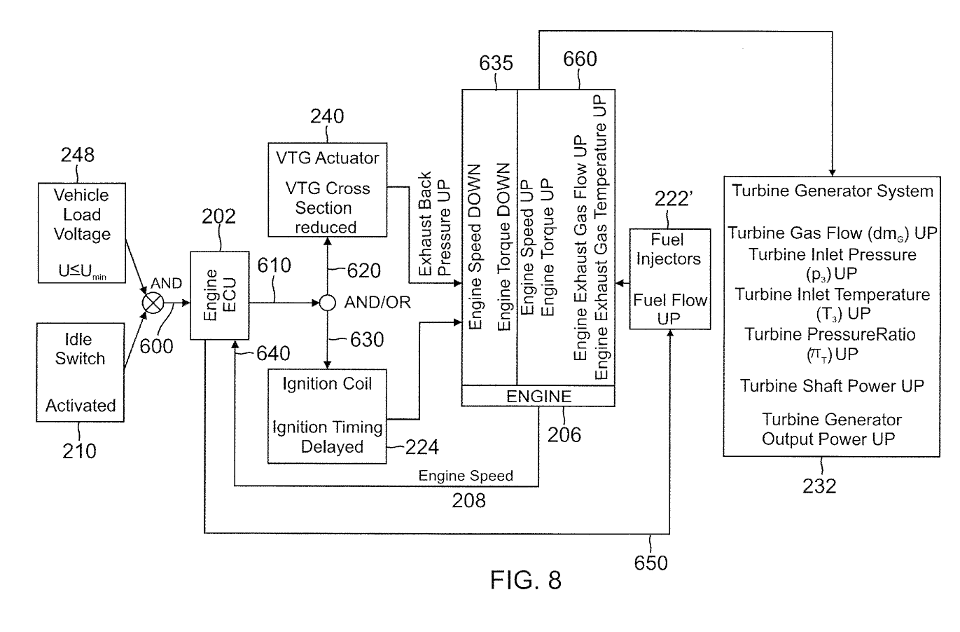

FIG. 8 is a signal flow chart corresponding to FIG. 7. Referring to FIG. 7 and FIG. 8, when the engine ECU 202 receives information that the idle switch 210 is activated, the engine ECU 202 determines that the engine is at idle. If the engine ECU 202 also determines that the voltage U (248) is equal to or has dropped below a predetermined voltage Uₘᵢₙ, the engine ECU 202 initiates an action to increase the voltage U (248). Accordingly, upon the engine ECU 202 determining that the engine is at idle and that the voltage U (248) is less than or equal to a predetermined voltage Uₘᵢₙ (step 600), the engine ECU 202 decreases the engine idle speed (step 610) by controlling the VTG actuator 240 to reduce the VTG cross-section width between the vanes 236 (step 620) in order to increase the back pressure on the exhaust gas 230. An increase of the back pressure on the exhaust gas 230 decreases the engine idle speed and the engine torque of the engine 206 (step 635). Alternatively, the engine ECU 202 may decrease the engine idle speed (step 610) and engine torque by controlling the ignition signal to the ignition coil 224 to delay the ignition timing (step 630). As such, the engine ECU 202 may control the VTG actuator 240 (step 620) and/or the ignition signal to the ignition coil 224 (step 630) in order to decrease the engine idle speed and the engine torque of the engine 206 (step 635). When the engine ECU 202 receives information 208 that the engine speed has decreased (step 640), the engine ECU 202 controls the fuel injector 222′ to provide more fuel for combustion in the engine 206 (step 650). The increase in fuel to the engine 206 results in an increase in engine speed and engine torque (step 660). The resulting engine speed after step 660 is approximately the same as the engine speed before the initial decrease in engine speed at step 610. The increase in engine speed and engine torque results in an increase in engine exhaust gas temperature, an increase in engine exhaust gas flow (step 660), and an increase in turbine inlet pressure. That is, more exhaust gas with higher temperature flows through the turbine with a higher expansion ratio (pressure ratio) over the turbine. That increases the turbine shaft power (generator input power) and, consequently, increases the turbine generator output power. Accordingly, the generator 242 may generate a sufficient AC power, which upon being rectified by the rectifier 244 and controlled by the DC-DC converter 246, is provided as power with voltage U (248) (see FIG. 7) for supplying power to the vehicle electrical load and for charging the battery 204.

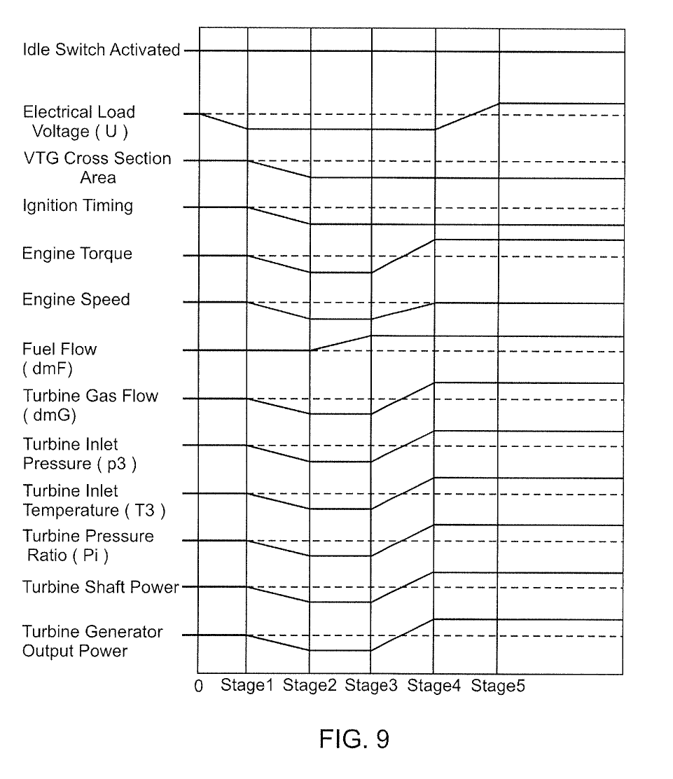

FIG. 9 is a device/parameter state chart corresponding to FIG. 7. At stage 0, the idle switch is activated, which indicates that the engine is at idle. At stage 1, the electrical load voltage U has fallen such that the voltage U is less than or equal to a predetermined voltage. As discussed supra, the system increases the electrical output power of the exhaust gas turbine generator system only when the engine is at idle and the voltage U is less than or equal to the predetermined voltage Uₘᵢₙ. At stage 2, the VTG cross-section width is decreased and/or the ignition timing is delayed, which results in a decrease in the engine torque and engine speed. Concurrently, the turbine gas flow, the turbine inlet pressure, the turbine inlet temperature, the turbine pressure ratio, the turbine shaft power, and the turbine generator electrical output power all decrease. At stage 3, the fuel flow into the engine is increased. As a result, at stage 4, the engine torque, the engine speed, the turbine gas flow, the turbine inlet pressure, the turbine inlet temperature, the turbine pressure ratio, the turbine shaft power, and the turbine generator electrical output power all are increased. At stage 5, the electrical load voltage U is increased as a result of the increase in electrical output power of the exhaust gas turbine generator system.

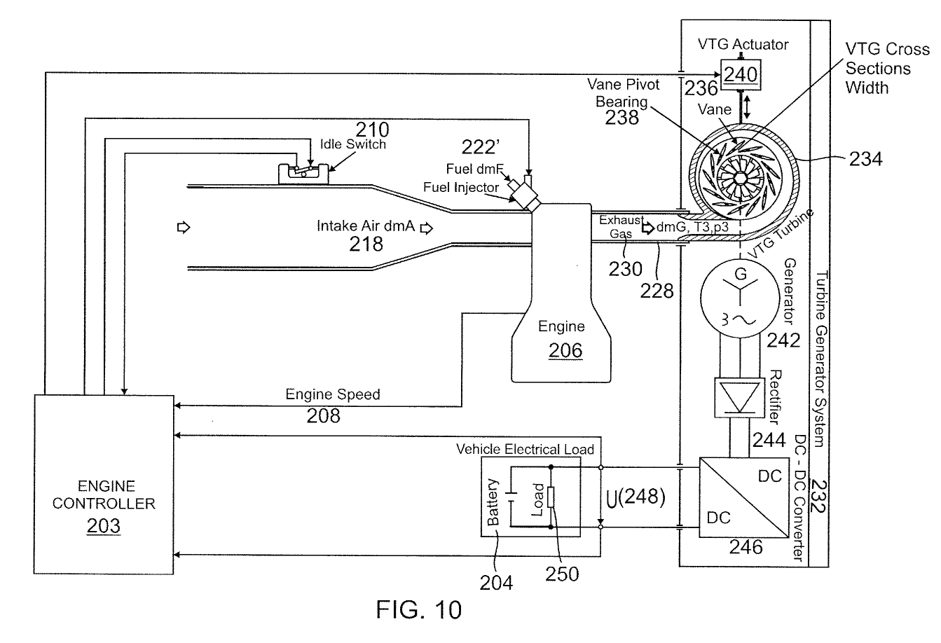

FIG. 10 is a technology schematic of the system of FIG. 1 according to a sixth configuration. As shown in FIG. 10, the controller 110 is the engine controller 203. However, as discussed supra, the controller 110 may be a separate component from the engine controller 203. The engine controller 203 is coupled to and powered by the battery 204 and/or the generator as part of the load. Accordingly, the engine controller 203 receives voltage U (248). The engine controller 203 receives information on whether the engine 206, which is a compression ignition engine (diesel engine), is at idle from the idle switch 210. When the idle switch 210 is activated, the engine 206 is at idle. The engine controller 203 receives engine speed information 208 from the engine 206. Depending on the engine speed information 208, the engine controller 203 controls the fuel injector 222′ configured for electronic/mechanic injection control.

The engine 206 is coupled to the exhaust outlet 228. Exhaust gas 230 from the engine 206 flows out the exhaust outlet 228 and through the VTG turbine 234 of the turbine generator system 232. The VTG turbine 234 includes a plurality of vanes 236, which can be rotated clockwise or counterclockwise via pivot bearing 238. When the vanes 236 are rotated counterclockwise, the VTG cross-section width increases, and when the vanes 236 are rotated clockwise, the VTG cross-section width decreases. As the VTG cross-section width decreases, the back pressure on the exhaust gas 230 increases, as there is less area through which the exhaust gas 230 can flow. The vanes 236 are controlled by the VTG actuator 240, which itself is coupled to the engine controller 203. The VTG turbine 234 includes generator 242. The generator 242 generates an AC voltage, which is rectified by the rectifier 244. A DC-DC converter 246 is coupled to the rectifier 244. The DC-DC converter 246 provides a voltage U (248) across vehicle electrical load 250 for providing power to the vehicle electrical load 250 and for charging the battery 204.

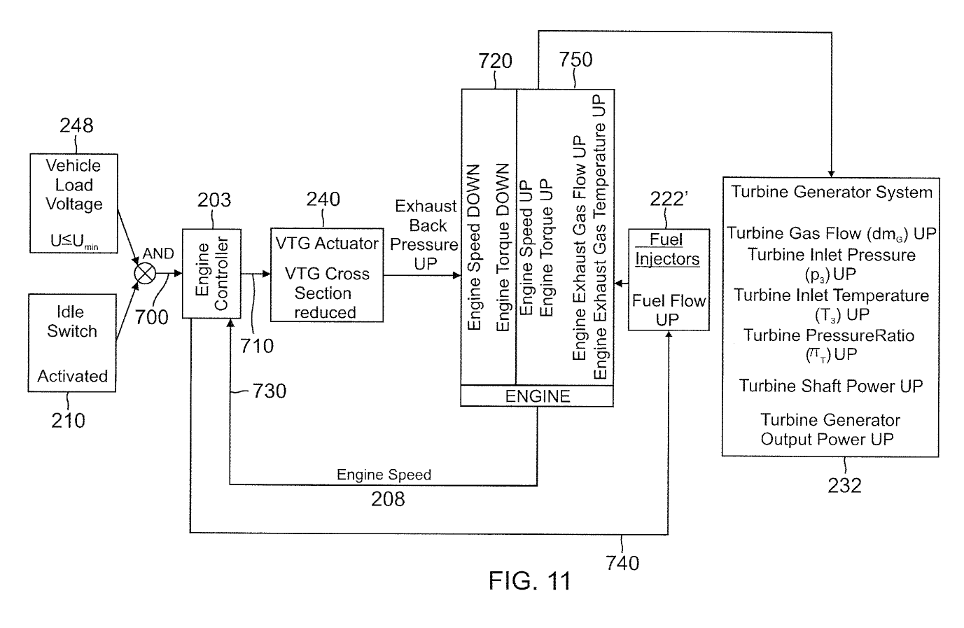

FIG. 11 is a signal flow chart corresponding to FIG. 10. Referring to FIG. 10 and FIG. 11, when the engine controller 203 receives information that the idle switch 210 is activated, the engine controller 203 determines that the engine is at idle. If the engine controller 203 also determines that the voltage U (248) is equal to or has dropped below a predetermined voltage Uₘᵢₙ, the engine controller 203 initiates an action to increase the voltage U (248). Accordingly, upon the engine controller 203 determining that the engine is at idle and that the voltage U (248) is less than or equal to a predetermined voltage Uₘᵢₙ (step 700), the engine controller 203 decreases the engine idle speed by controlling the VTG actuator 240 to reduce the VTG cross-section width between the vanes 236 (step 710) in order to increase the back pressure on the exhaust gas 230. An increase of the back pressure on the exhaust gas 230 decreases the engine idle speed and the engine torque of the engine 206 (step 720). When the engine controller 203 receives information 208 that the engine speed has decreased (step 730), the engine controller 203 controls the fuel injector 222′ to provide more fuel for combustion in the engine 206 (step 740). The increase in fuel to the engine 206 results in an increase in engine speed and engine torque (step 750). The resulting engine speed after step 750 is approximately the same as the engine speed before the initial decrease in engine speed at step 710. The increase in engine speed and engine torque results in an increase in engine exhaust gas temperature, an increase in engine exhaust gas flow (step 750), and an increase in turbine inlet pressure. That is, more exhaust gas with higher temperature flows through the turbine with a higher expansion ratio (pressure ratio) over the turbine. That increases the turbine shaft power (generator input power) and, consequently, increases the turbine generator output power. Accordingly, the generator 242 may generate a sufficient AC power, which upon being rectified by the rectifier 244 and controlled by the DC-DC converter 246, is provided as power with voltage U (248) (see FIG. 10) for supplying power to the vehicle electrical load and for charging the battery 204.

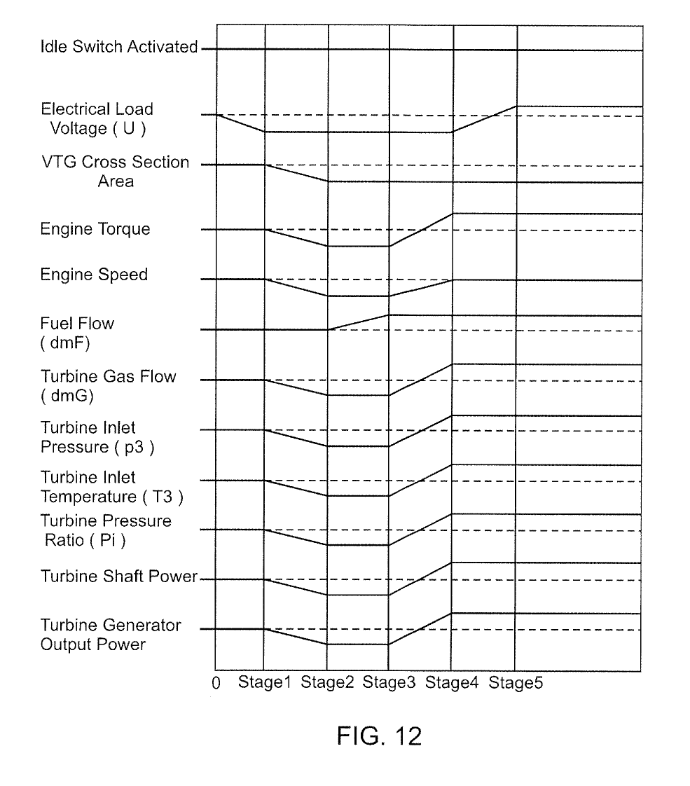

FIG. 12 is a device/parameter state chart corresponding to FIG. 10. At stage 0, the idle switch is activated, which indicates that the engine is at idle. At stage 1, the electrical load voltage U has fallen such that the voltage U is less than or equal to a predetermined voltage. As discussed supra, the system increases the electrical output power of the exhaust gas turbine generator system only when the engine is at idle and the voltage U is less than or equal to the predetermined voltage Uₘᵢₙ. At stage 2, the VTG cross-section width is decreased, which results in a decrease in the engine torque and engine speed. Concurrently, the turbine gas flow, the turbine inlet pressure, the turbine inlet temperature, the turbine pressure ratio, the turbine shaft power, and the turbine generator electrical output power all decrease. At stage 3, the fuel flow into the engine is increased. As a result, at stage 4, the engine torque, the engine speed, the turbine gas flow, the turbine inlet pressure, the turbine inlet temperature, the turbine pressure ratio, the turbine shaft power, and the turbine generator electrical output power all are increased. At stage 5, the electrical load voltage U is increased as a result of the increase in electrical output power of the exhaust gas turbine generator system.

The engine ECU/controller may be configured to execute software. The engine ECU/controller may be a microprocessor capable of accessing software on machine-readable media. The microprocessor may be an integrated circuit linked together with machine-readable media and other circuitry through a bus or other communication means. For the diesel engine (see FIG. 10), the engine controller is an electronic/mechanic controller.

Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, or any other suitable storage medium, or any combination thereof.

The software supported by the machine-readable media may reside in a single storage device or distributed across multiple memory devices. During execution of the software, the processor may load some of the instructions into cache to increase access speed. One or more cache lines may then be loaded into a general register file for execution by the processor. When referring to the functionality of software, it will be understood that such functionality is implemented by the processor when executing software instructions.

The various aspects of this disclosure are provided to enable one of ordinary skill in the art to practice the present invention. Modifications to various aspects of a system for increasing electrical output power of an exhaust gas turbine generator system presented throughout this disclosure will be readily apparent to those skilled in the art, and the concepts disclosed herein may be extended to other applications, such as non-vehicle applications having components similar in function to the vehicle components 180. Thus, the claims are not intended to be limited to the various aspects of a system for increasing electrical output power of an exhaust gas turbine generator system presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for increasing electrical power, comprising:
an exhaust gas turbine configured to be driven by exhaust gas from an engine;
a generator coupled to the exhaust gas turbine to produce electrical power for an electrical load; and
a controller configured to increase the electrical power produced by the generator in response to a certain decrease in an electrical load voltage of the electrical load when the engine is at idle,
wherein the controller increases the electrical power by increasing an energy throughput of the exhaust gas through the exhaust gas turbine.

2. The system of claim 1, wherein while the engine is at idle, the controller is configured to increase a back pressure of the exhaust gas and to increase fuel provided to the engine.

3. The system of claim 2, wherein while the engine is at idle, the controller is further configured to increase air flow into the engine.

4. The system of claim 1, wherein while the engine is at idle, the controller is configured to delay an ignition timing of the engine and to increase fuel provided to the engine.

5. The system of claim 4, wherein while the engine is at idle, the controller is further configured to increase air flow into the engine.

6. The system of claim 1, wherein the exhaust gas turbine is a variable turbine geometry turbine and comprises a plurality of vanes, and the controller is configured to rotate the plurality of vanes.

7. The system of claim 6, further comprising a variable turbine geometry actuator coupled to the controller and to the variable turbine geometry turbine; wherein the controller is configured to control the variable turbine geometry actuator to rotate the plurality of vanes.

8. The system of claim 6, further comprising:
an engine for outputting the exhaust gas,
wherein the electrical load comprises a battery and a load,
wherein the controller is configured to monitor the electrical load voltage, and
wherein the controller is configured to increase the energy throughput of the exhaust gas through the exhaust gas turbine when the electrical load voltage is less than or equal to a threshold.

9. The system of claim 8, wherein after the controller increases the electrical power of the generator, the controller is configured to deactivate the system when the electrical load voltage crosses a second threshold.

10. The system of claim 8, further comprising an idle switch, wherein the controller determines that the engine is at idle when the idle switch is activated.

11. The system of claim 8, further comprising:
a rectifier coupled to the generator; and
a DC-DC converter coupled to the rectifier,
wherein the DC-DC converter is configured to provide a controlled voltage to the electrical load.

12. The system of claim 8, further comprising:
at least one spark plug coupled to the engine;
an ignition coil coupled to the at least one spark plug;
a throttle configured to allow intake air into the engine; and
a fuel injector configured to provide fuel to the engine,
wherein the controller is coupled to the ignition coil for controlling an ignition timing, to the engine for receiving engine speed information, and to the fuel injector for controlling an amount of the fuel provided to the engine.

13. The system of claim 12, further comprising an air flow meter configured to measure the amount of the intake air flowing into the engine, wherein the controller is coupled to the air flow meter for receiving information on the amount of intake air flowing into the engine.

14. The system of claim 13, further comprising a throttle actuator coupled to the throttle, wherein to increase electrical power of the generator, the controller is configured to:
decrease an engine idle speed of the engine either by controlling a signal to the ignition coil to delay the ignition timing or by rotating the plurality of vanes to decrease a width between adjacent vanes in order to increase a back pressure on the exhaust gas;
receive the engine speed information from the engine;
increase the intake air into the engine, depending on the received engine speed information, by controlling the throttle actuator;
receive the information on the amount of the intake air flowing into the engine from the air flow meter; and
increase the engine idle speed and torque by controlling the fuel injector to increase the amount of the fuel provided to the engine depending on the received information on the amount of intake air flowing into the engine.

15. The system of claim 13, further comprising an air bypass value configured to allow the intake air to bypass the throttle and an air bypass valve actuator coupled to the air bypass valve, wherein to increase the electrical output power of the generator, the controller is configured to:
decrease an engine idle speed of the engine either by controlling a signal to the ignition coil to delay the ignition timing or by rotating the plurality of vanes to decrease a width between adjacent vanes in order to increase a back pressure on the exhaust gas;
receive the engine speed information from the engine;
increase the intake air into the engine, depending on the received engine speed information, by controlling the air bypass valve actuator;
receive the information on the amount of the intake air flowing into the engine from the air flow meter; and
increase the engine idle speed and torque by controlling the fuel injector to increase the amount of the fuel provided to the engine depending on the received information on the amount of intake air flowing into the engine.

16. The system of claim 12, wherein to increase electrical power of the generator, the controller is configured to:
decrease an engine idle speed of the engine either by controlling a signal to the ignition coil to delay the ignition timing or by rotating the plurality of vanes to decrease a width between adjacent vanes in order to increase a back pressure on the exhaust gas;
receive the engine speed information from the engine; and
increase the engine idle speed and torque by controlling the fuel injector to increase the amount of the fuel provided to the engine.

17. The system of claim 8, further comprising a fuel injector configured to provide fuel to the engine, wherein the controller is coupled to the engine for receiving engine speed information and to the fuel injector for controlling an amount of the fuel provided to the engine.

18. The system of claim 17, wherein to increase electrical power of the generator, the controller is configured to:
decrease an engine idle speed of the engine by rotating the plurality of vanes to decrease a width between adjacent vanes in order to increase a back pressure on the exhaust gas;
receive the engine speed information from the engine; and
increase the engine idle speed and torque by controlling the fuel injector to increase the amount of the fuel provided to the engine.

19. A method for providing additional electrical power to an electrical load while an engine is at idle, comprising:
increasing a flow of exhaust gas from the engine through an exhaust gas turbine in response to a certain decrease in an electrical load voltage of the electrical load; and
increasing electrical power to the electrical load through the increase in the exhaust gas flow through the exhaust gas turbine.

20. The method of claim 19, further comprising:
terminating the providing of additional electrical power to the electrical load when the electrical load voltage crosses a threshold.

21. The method of claim 19, wherein increasing the exhaust gas flow comprises:
decreasing an engine speed of an engine of the vehicle while at idle either by delaying the ignition timing or by increasing a back pressure on the flow of the exhaust gas;
receiving the engine speed information from the engine;
increasing intake air into the engine, depending on the received engine speed information;
receiving information on an amount of the intake air flowing into the engine; and
increasing the engine idle speed and torque of the engine by increasing an amount of fuel provided to the engine depending on the received information on the amount of intake air flowing into the engine.

22. The method of claim 21, wherein the engine speed before the engine idle speed is decreased and the engine speed after the engine idle speed is increased are approximately the same.

23. The method of claim 21, wherein the exhaust gas turbine is a variable turbine geometry turbine, the exhaust gas turbine comprises a plurality of vanes, and the back pressure on the flow of the exhaust gas is increased by rotating the plurality of vanes in order to decrease a width between adjacent vanes such that an area through which the exhaust gas can flow is decreased.

24. The method of claim 19, wherein increasing the exhaust gas flow comprises:
decreasing an engine speed of an engine of the vehicle while at idle either by delaying the ignition timing or by increasing a back pressure on the flow of the exhaust gas;
receiving the engine speed information from the engine; and
increasing the engine idle speed and torque of the engine by increasing an amount of fuel provided to the engine.

25. A system for increasing electrical power, comprising:
means for producing electrical power from a flow of exhaust gas from an engine, the means for producing electrical power being configured to provide the electrical power to an electrical load; and
means for increasing the electrical power provided to the electrical load by increasing a throughput of the energy flow of the exhaust gas through the means for generating power,
wherein the means for increasing the electrical power is configured to increase the electrical power in response to a certain decrease in an electrical load voltage of the electrical load when the engine is at idle.

26. The system of claim 25, wherein while the engine is at idle, the means for increasing electrical power is configured to increase a back pressure of the exhaust gas and increase fuel provided to the engine.

27. The system of claim 26, wherein while the engine is at idle, the means for increasing electrical power is also configured to increase air flow into the engine.

28. The system of claim 25, wherein while the engine is at idle, the means for increasing electrical power is configured to delay an ignition timing of the engine and increase fuel provided to the engine.

29. The system of claim 28, wherein while the engine is at idle, the means for increasing electrical power is also configured to increase air flow into the engine.

30. The system of claim 25, further comprising:
an engine configured to output the exhaust gas,
wherein the electrical load comprises a battery and a load,
wherein the means for increasing electrical power is configured to monitor the electrical load voltage, and
wherein the means for increasing the electrical power is configured to increase the throughput of the exhaust gas through the means for producing electrical power when the engine is at idle and the electrical load voltage is less than or equal to the threshold.

31. The system of claim 25, wherein the means for producing electrical power comprises an exhaust gas turbine and a generator coupled to the exhaust gas turbine, and the means for increasing electrical power comprises a controller.

32. A vehicle having a system for increasing electrical power, comprising:
an electrical load including a battery and a vehicle electrical load;
an engine configured to output exhaust gas;
an exhaust gas turbine configured to be driven by the exhaust gas from an engine;
a generator coupled to the exhaust gas turbine to output electrical power to the electrical load; and
a controller configured to increase the electrical power produced by the generator when the engine is at idle and an electrical load voltage of the electrical load crosses a threshold,
wherein the controller increases the electrical power by increasing a throughput of the exhaust gas through the exhaust gas turbine.

33. An apparatus for use in an automobile, comprising:
a variable turbine geometry (VTG) turbine configured to be driven by exhaust gas from an engine; and
a generator coupled to the VTG turbine to produce electrical power for an electrical load.

34. The apparatus of claim 33, wherein the VTG turbine comprises a plurality of movable vanes to control the exhaust gas flow into the VTG turbine.

35. The apparatus of claim 34, wherein the vanes are configured to be moved by a variable turbine geometry actuator.

36. An apparatus for use in an automobile, comprising:
an exhaust gas turbine configured to be driven by exhaust gas from an engine, wherein the exhaust gas turbine comprises means for varying an energy throughput of the exhaust gas through the exhaust gas turbine; and
a generator coupled to the exhaust gas turbine to produce electrical power for an electrical load, wherein the electrical power produced by the generator is based on the energy throughput of the exhaust gas through the exhaust gas turbine.
